(19) United States
(12) Patent Application Publication
(10) Pub. No.: US 2013/0268543 A1
(43) Pub. Date: Oct. 10, 2013

(54) SYSTEM AND METHOD FOR RECOMMENDING CONTENT

(71) Applicant: MYSPACE LLC, Beverly Hills, CA (US)

(72) Inventors: Michael Scott Andler, Los Angels, CA (US); James Andrew Beaupre, Los Angeles, CA (US); Eric J. Kim, Tujunga, CA (US); Thomas B Werz III, Los Angeles, CA (US)

(73) Assignee: MySpace LLC, Beverly Hills, CA (US)

(21) Appl. No.: 13/858,727

(22) Filed: Apr. 8, 2013

Related U.S. Application Data
(60) Provisional application No. 61/621,049, filed on Apr. 6, 2012.

(51) Int. Cl. G06F 17/30

(52) U.S. Cl. CPC G06F 17/30595
USPC 707/748

(57) ABSTRACT

A method, system, apparatus, and computer program product provide the ability to recommend content to a particular user. Two content recommendation techniques are implemented and generated different content recommendation scores that are relative to a particular piece of content and the particular user. The two scores are reconciled to generate an overall content recommendation score for the particular piece of content and the particular user.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Application Ser. No. 61/621,049, filed on Apr. 6, 2012, by Mike Andler, James Andrew Beaupre, Eric Juhyun Kim, and Thomas Barraud Werz III, entitled “System and Method for Recommending Content”, attorneys' docket number 257.44-US-P1

This application is related to the following co-pending and commonly-assigned patent application(s), which is/are incorporated by reference herein:

U.S. patent application Ser. No. 13/528,368 filed on Jun. 20, 2012, entitled “System and Method for Determining the Relative Ranking of a Network Resource” by Thomas B. Werz III, James Beaupre, and Eric J. Kim, attorneys' docket number 257.33-US-U1, which application claims the benefit of U.S. Provisional Patent Application Ser. No. 61/498,666, filed on Jun. 20, 2011, by Thomas B. Werz III, James A. Beaupre, and Eric J. Kim, entitled “System and Method Determining the Relative Ranking of a Network Resource in a Distributed Environment”, “attorneys' docket number 257.33-US-P1;

U.S. patent application Ser. No. 13/528,679, filed on Jun. 20, 2012, by Thomas B. Werz III, James A. Beaupre, and Eric J. Kim, entitled “System and Method of Tracking User Interaction with Content”, attorneys' docket number 257.39-US-U1, which application claims the benefit of United States Provisional Application Ser. No. 61/498,674, filed on Jun. 20, 2011, by Thomas B. Werz III, James A. Beaupre, and Eric J. Kim, entitled “System and Method of Tracking User Interaction with Content”, attorneys' docket number 257.39-US-P1;

U.S. patent application Ser. No. ______, filed on Apr. 8, 2013, by Michael Scott Andler, James A. Beaupre, Eric J. Kim, and Thomas B. Werz III, entitled “System and Method for Presenting and Managing Social Media”, attorneys' docket number 257.40-US-U1, which application claims the benefit of U.S. Provisional Patent Application Ser. No. 61/621,057 filed on Apr. 6, 2012, entitled “System and Method for Presenting and Managing Social Media” by Mike Andler, James Andrew Beaupre, Eric Juhyun Kim, and Thomas Barraud Werz III, attorneys' docket number 257.40-US-P1; and U.S. patent application Ser. No. ______, filed on Apr. 8, 2013, by Michael Scott Andler, James A. Beaupre, Eric J. Kim, and Thomas B. Werz III, entitled “System and Method for Determining User or Resource Influence within a Pre-Defined Context”, attorneys' docket number 257.43-US-U1, which application claims the benefit of U.S. Provisional Application Ser. No. 61/621,051, filed on Apr. 6, 2012, by Mike Andler, James Andrew Beaupre, Eric Juhyun Kim, and Thomas Barraud Werz III, entitled “System and Method for Determining User or Resource Influence within a Pre-Defined Context”, attorneys' docket number 257.43-US-P1.

U.S. patent application Ser. No. 13/786,173, filed on Mar. 5, 2013, by Jason J. A. Knapp, entitled “User and Content Recommendation and Discovery Application”, attorneys' docket number 257.8-US-U1, which application claims the benefit of U.S. Patent Application Ser. No. 61/606,869, entitled “User and Content Recommendation and Discovery Application”, by Jason J. A. Knapp, filed on Mar. 5, 2012, Attorney Docket No. 257.8-US-P1.

### BACKGROUND OF THE INVENTION

1. Field of the Invention

This invention relates generally to methods and systems for recommending content. More particularly, this invention relates to improved methods and systems of recommending content to users using plural recommendation techniques.

2. Description of the Related Art

Generally, the concept of content recommendations is known and has been implemented. Common systems include manual publishing of playlists or content by a user or friends of users, or basic comparison of a user's library with other user's libraries, with or without factoring a user's playing habits with regard to those libraries. However, current methods are still plagued by false positive matches of content with users. Such problems are even more compounded as the amount of available content increases.

Accordingly, there is a need in the art for an improved system and method for recommending content to users.

### SUMMARY OF THE INVENTION

The above described and other problems and disadvantages of the prior art are overcome and alleviated by the present system and method of recommending content to users by using plural recommendation scoring techniques. Some exemplary techniques compare content to previously consumed content by a user or other users associated with a user. In exemplary embodiments, such comparisons result in content recommendations for which users have a strong affinity. Exemplary processes for discovering relevant content include one or more of content characterization, tagging, relationship scoring and frame scoring, among others.

Exemplary embodiments herein can be configured to provide deeply accurate methods by which users of a content rich system can be introduced to relevant content from other sources, e.g., friends, acquaintances, like-minded users, nearby events, and celebrities, among others. By combining plural techniques of content assessment relative to a user, the expanded set of variables resultant therefrom can be used to greatly improve the accuracy of matches.

In further exemplary embodiments, any of the plural processes may include weighted scores as desired to adjust the likelihood of recommendation. For example, frame scoring may include weighted scores for activities involving users or resources on a site that themselves have higher activity scores. In exemplary embodiments, these users or resources that have higher interactivity with other users or resources may be considered to have a higher frame score. Further weights may be applied to activities such that more famous users or resources affect the frame scores of other users or resources more than less famous users or resources.

Also, influence score and fan score may be contributing factors to the weighting of recommendations. In exemplary embodiments, not all users may have frame, but they may have influence and fan scores (or vice versa).

In exemplary embodiments, similar effects can be constructed within, e.g., relationship scoring, where users more tightly affiliated with a particular user affect content recommendation scoring more than other users that are less tightly affiliated with that user.

Further, the relative effectiveness of each of the plural processes can be weighted as desired, e.g., where frame scoring is weighted to affect recommendations more than content characterization.

The above discussed and other features and advantages of the present invention will be appreciated and understood by those skilled in the art from the following detailed description and drawings.

### BRIEF DESCRIPTION OF THE DRAWINGS

Referring now to the drawings in which like reference numbers represent corresponding parts throughout:

FIG. 1 illustrates an exemplary method of determining the influence of a user or resource within a pre-defined context in accordance with one or more embodiments of the invention;

FIG. 2 illustrates the logical flow for recommending content to a particular user in accordance with one or more embodiments of the invention;

FIG. 3 is an exemplary hardware and software environment used to implement one or more embodiments of the invention; and

FIG. 4 schematically illustrates a typical distributed computer system using a network to connect client computers to server computers in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention. Embodiments of the invention include systems and methods for presenting and managing social media that utilize one or more of various subsystems. Exemplary subsystems will be described in turn, followed by a discussion of their context in the system architecture and a discussion of system and method flow.

### Recommendations—a System and Method for Recommending Content

As described herein, example embodiments of the present invention may include methods and systems of recommending content to users by using plural recommendation scoring techniques. Some exemplary techniques compare content to previously consumed content by a user or other users associated with a user. In exemplary embodiments, such comparisons result in content recommendations for which users have a strong affinity. Exemplary processes for discovering relevant content include one or more of content characterization, tagging, relationship scoring and frame scoring, among others.

Exemplary embodiments herein can be configured to provide deeply accurate methods by which users of a content rich system can be introduced to relevant content from other sources, e.g., friends, acquaintances, like-minded users, nearby events, and celebrities, among others. By combining plural techniques of content assessment relative to a user, the expanded set of variables resultant therefrom can be used to greatly improve the accuracy of matches.

In further exemplary embodiments, any of the plural processes may include weighted scores as desired to adjust the likelihood of recommendation. For example, frame scoring may include weighted scores for activities involving users or resources on a site that themselves have higher activity scores. In exemplary embodiments, these users or resources that have higher interactivity with other users or resources may be considered to have a higher frame score. Further weights may be applied to activities such that more famous users or resources affect the frame scores of other users or resources more than less famous users or resources.

In exemplary embodiments, similar effects can be constructed within, e.g., relationship scoring, where users more tightly affiliated with a particular user affect content recommendation scoring more than other users that are less tightly affiliated with that user.

Further, the relative effectiveness of each of the plural processes can be weighted as desired, e.g., where frame scoring is weighted to affect recommendations more than content characterization.

### Frame Score—a System and Method for Determining User or Resource Influence Within a Pre-Defined Context

As described herein, example embodiments of the present invention may include systems and methods of determining the influence of a user or resource within a pre-defined context (also referred to as a user's frame). In exemplary embodiments, systems and methods described herein assign point values to all activities that may occur within that pre-defined context. In exemplary embodiments, the systems and methods are thus used to determine a user's or resource's global popularity, relevance, and/or desirability based on activities it is or has been associated with.

Thus, exemplary embodiments advantageously provide a uniform scoring mechanism by which any and all activities occurring within a global system can be rated, judged or defined in a mathematical and uniform manner.

In further exemplary embodiments, such determinations may be made over discrete time intervals or in real time across all activities associated with the user or resource. In other exemplary embodiments, such determinations may be made in category specific contexts, including but not limited to a social networking site, point based contests, promotions, games and marketing, among other examples.

In other exemplary embodiments, the systems and methods provide/assign weighted scores to users or resources, such that activities associated with higher scored users or resources affect other users or resources more significantly than lower rated users or resources. Exemplary embodiments also provide awards to higher scored users or resources, for example by way of increased usage opportunity, marketing advantages, feature targeting and higher visibility to the masses, among others.

In another exemplary embodiment, such systems and methods provide a frame score for a user or resource on a social networking site by assigning such point values to all activities on the social networking site. As in other exemplary embodiments, an exemplary weighted scoring may be utilized to allow more famous users or resources to affect the scores of other users or resources more significantly than less famous users or resources, thus rewarding the importance of celebrity influence and organic global reach.

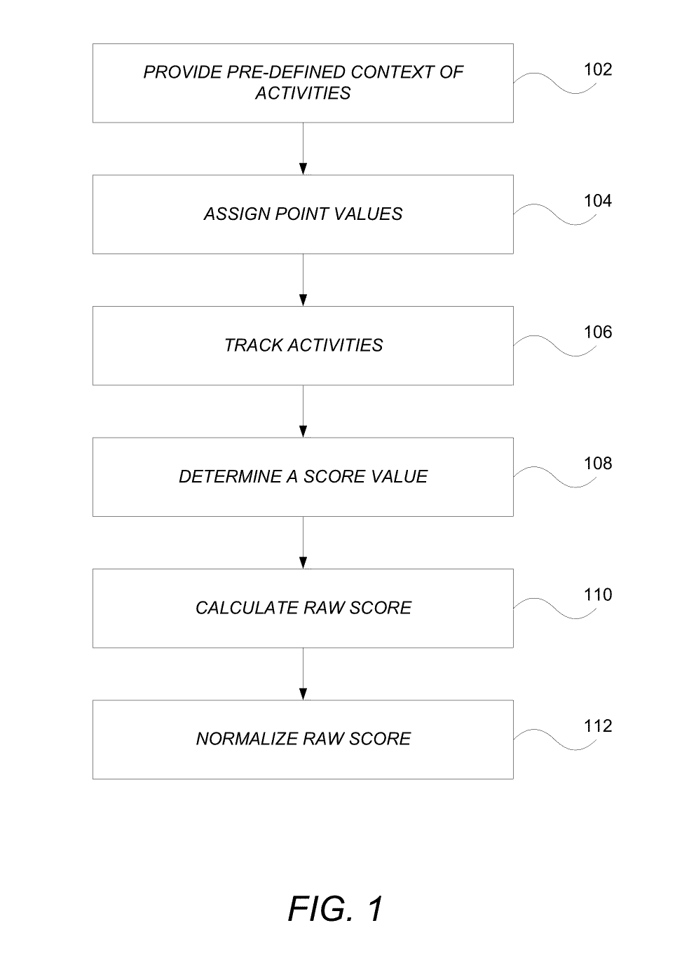

FIG. 1 illustrates an exemplary method of determining the influence of a user or resource within a pre-defined context in accordance with one or more embodiments of the invention. The determined influence may be used to gauge or identify a user/resource's global popularity, relevance, and/or desirability based on activities the user/resource has been associated with.

At step 102, a pre-defined context of activities is provided. Such a pre-defined context defines the bounds for determining the influence of a user. For example, the pre-defined context may be category specific such as across a social network site, within a point-based contest, within a promotion/promotional activity, within a game and/or marketing, etc.

At step 104, point values are assigned to all activities that may occur within that pre-defined context. Examples of such activities include anything that a user does relative to another person, object, etc.

As used herein, an activity can be defined as any and all interactions that may occur in the pre-defined context. For example, on a network site, such activities can include anything that a user does relative to another person, object, uniquely identifiable resource, etc., or vice versa. Examples of user activities may include clicking through an advertisement, adding a new friend of a social network, expanding a social network, posting real user activities (e.g., status updates, events, etc), uploading and/or sharing multimedia, sharing photos, sharing video, sharing music, or any other suitable activity. Furthermore, user activities may include clicking, accessing, or sharing content already uploaded to the website. For example, a user may access video, music, or any other suitable material posted by a friend or member of a social network, and thus these activities may be tracked. Additionally, a user may click a shared web-link, URL, or other dynamic content previously posted, and thus these activities may also be tracked. Moreover, any other useful or meaningful user activity including new user registration, increasing/decreasing number of friends, web sales, photo deletion, content removal, etc. may also be tracked. It is also noted that the activities described above are only examples of possible activities to be tracked, and should not be construed as limiting.

In view of the above, a point value (e.g., 1, 2, etc.) may be assigned to each activity. Certain activities may have a higher point value than other activities. For example, on a social network site, sharing music/video may have a higher point value than merely adding a new friend. Accordingly, the point values serve to identify the intrinsic value of an activity. In addition, the point values may vary depending on both the pre-defined context as well as the frequency of the activity. For example, if a user has 5000 friends, adding another friend may not be associated with as high a point value compared to a user that only has 10 friends. Similarly, if a user shares a song/music 100 times in a day, the music sharing activity may not have as high a point value compared to a user that only shares 2 songs over the same time period. In this regard, the point values may be defined on a scale that varies based on the context and frequency.

At step 106, all activities for a single user or resource within the pre-defined context are tracked over a period of time (e.g., a discrete time interval or in real-time across all activities associated with the user or resource).

At step 108, a score value for each activity for the single user or resource within the pre-defined context over a period of time is determined (e.g., based on the point values).

At step 110, a raw score is calculated for the single user or resource according to the total of all of the determined score values.

At step 112, the raw score value is normalized against scores of a population of other users or resources within the pre-determined context to provide a comparative scoring for users or resources within the pre-defined context.

Once a frame score (e.g., the normalized score) has been computed, various embodiments of the invention may opt to utilize the score. Such a utilization may include determining/providing advertising based on the score, providing benefits to users with certain scores (e.g., monetary benefit, awards, rewards, etc.). Alternatively, the utilization may include displaying the score in association with the relevant user/content.

### Logical Flow for Recommending Content

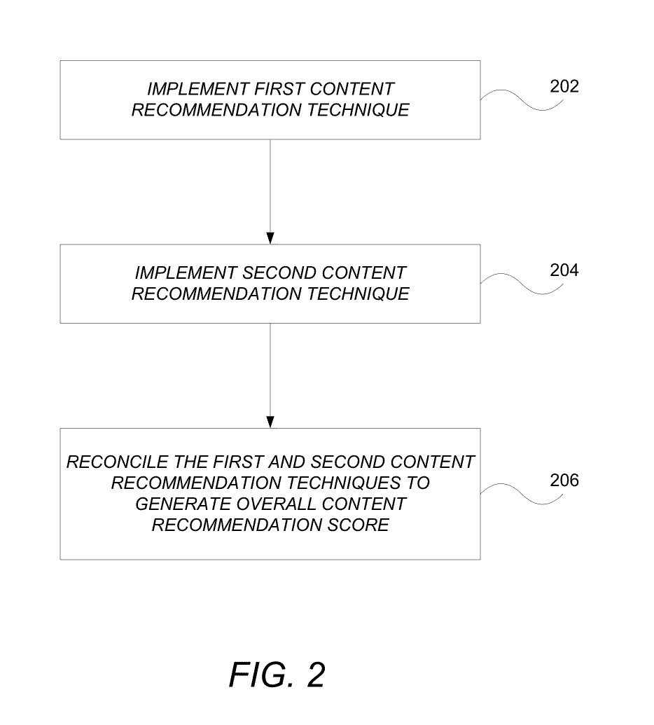

FIG. 2 illustrates the logical flow for recommending content to a particular user in accordance with one or more embodiments of the invention.

At step 202, a first content recommendation technique is implemented. The first content recommendation technique generates a first content recommendation score relative to a particular piece of content and the particular user.

At step 204, a second content recommendation technique is implemented. The second content recommendation technique generates a second content recommendation score relative to the particular piece of content and the particular user. The first and/or second content recommendation techniques may be based on a characterization of particular piece of content, tags (e.g., assigned to the particular piece of content and the particular user), a relationship score (e.g., assigned between the particular piece of content and the particular user), a frame score (e.g., assigned to the particular piece of content and/or the particular user), etc. If one of the techniques is based on a frame score, the steps of FIG. 1 above may be performed to determine the score.

At step 206, the first and said second content recommendation scores are reconciled to generate an overall content recommendation score for the particular piece of content and the particular user.

During the reconciliation, weighting may be applied to the first and/or second content recommendation scores. In this regard, depending on attributes associated with the first and/or second scores as well as the techniques utilized to determine scores, the first and second scores may be weighted differently when computing an overall score.

For example, if a first score indicates a particular piece of content is very famous/popular/currently trending, while the second score indicates that the particular piece of content is in the same genre as music the user regularly listens to, the reconciliation may apply a heavier weighting factor to the first score relative to that of the second score. In another example, if the first score is based on a frame scoring technique but indicates the content is not famous and is only associated with one user recommendation while the second score indicates the content is in the same genre as music the user regularly listens to, the same weight may be applied equally to both scores or the second score may be weighted more heavily (or the first score may be weighted in a negative manner to further impact the overall score). Similarly, if a first user is good friends with (or has similar “likes” to) a second user, and the second user has a close affinity/relationship with a particular piece of content, such relationships (e.g., between both the first and second users as well as between the second user and the content) may be taken into account when computing the overall recommendation score.

In addition, more than two recommendation techniques may be combined with/without different weighting factors applied to each of the respective recommendations scores.

In view of the above, embodiments of the invention provide the ability to utilize/combine multiple different content recommendation techniques when determining whether to recommend a particular piece of content to a particular user. As described above, the characterization of the user/content, tags associated with the content/users, relationships between the users and/or the content, as well as the frame of the users/content may form the basis for the different recommendation techniques that are combined to determine whether content should be recommended.

In addition, once a overall recommendation score is computed, the overall score (as well as the recommendation techniques) may be utilized to determine how, when, and whether to recommend content to a user. In this regard, the context of the user's current actions may be utilized/combined with the recommendation score to determine whether to recommend particular content or not. For example, suppose a song has a high recommendation score compared to that of other songs. However, if the user is currently reading news articles, the song may not be recommended to the user (i.e., in such a context). In contrast, if the user is currently listening to music, the song with the highest recommendation score may be recommended to the user.

In addition, the score may be recomputed (e.g., dynamically in real-time) or filtered depending on the user's actions. For example, if the system determines that the user is currently listening to classical music, if the song with the highest recommendation score is a punk rock song, such a song may be filtered out from potential recommendations that are presented to the user. As an alternative to filtering (or in addition to filtering), if the scores are computed/re-computed in real-time/dynamically, such a punk-rock song may not have a high overall score and may not be presented to the user (e.g., the context/state of mind of the user is used to determine the recommendation score).

With respect to how content/users may be recommended, the recommendations may be provided via an advertisement, via a recommendation area of a social media network, by displaying a recommendation score in association with the content, etc. Thus, the overall recommendation score may/may not be displayed/presented to the user. Further, the user may have the option of selecting whether to display the score or not. In addition, the user may have the option of displaying how the recommendation score is computed. For example, the user may have the option of displaying the factors that were used to compute the overall score (e.g., by clicking or hovering over a recommendation score). In this regard, if a user hovers over a recommendation score, information may be displayed to the user (e.g., via a tooltip, pop-up window, etc.) indicating that different recommendation techniques/scores that were combined to determine why content was recommended or achieved the overall recommendation score (e.g., a display of frame score 50 and relationship score of 25). Such information may be displayed in a unique format that is understandable to the user (e.g., a Venn diagram, pie chart, text, video clip, etc.). Embodiments of the invention are not intended to be limited by the form in which the recommendation score is utilized/presented and/or how content is recommended.

### Hardware Environment

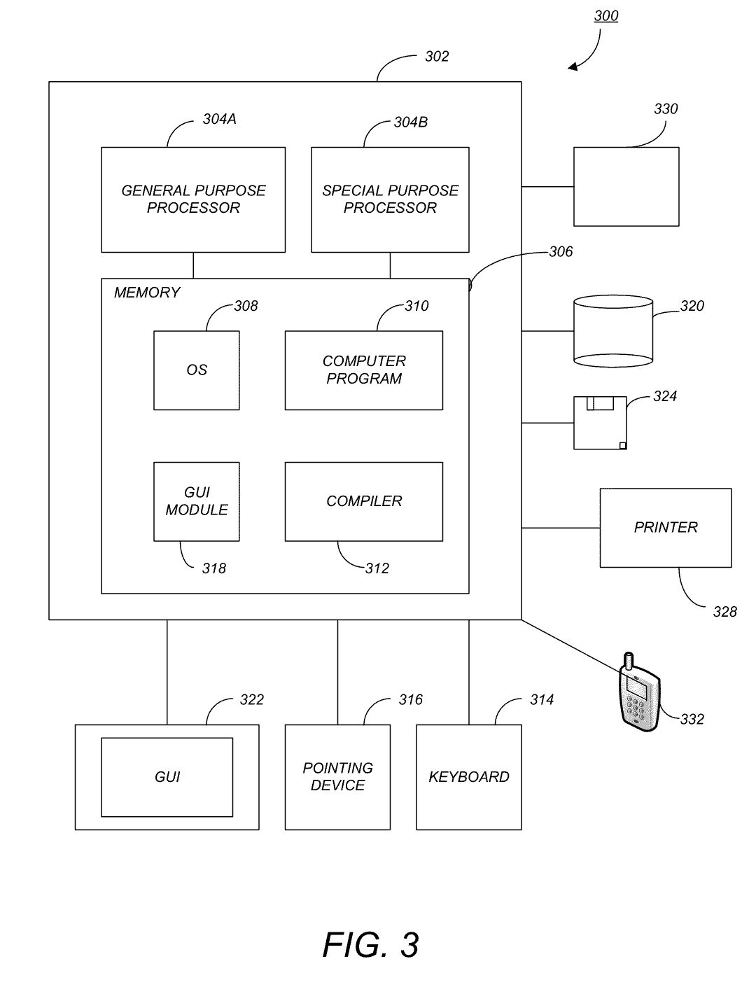

FIG. 3 is an exemplary hardware and software environment 300 used to implement one or more embodiments of the invention. The hardware and software environment includes a computer 302 and may include peripherals. Computer 302 may be a user/client computer, server computer, or may be a database computer. The computer 302 comprises a general purpose hardware processor 304A and/or a special purpose hardware processor 304B (hereinafter alternatively collectively referred to as processor 304) and a memory 306, such as random access memory (RAM). The computer 302 may be coupled to, and/or integrated with, other devices, including input/output (I/O) devices such as a keyboard 314, a cursor control device 316 (e.g., a mouse, a pointing device, pen and tablet, touch screen, multi-touch device, etc.) and a printer 328. In one or more embodiments, computer 302 may be coupled to, or may comprise, a portable or media viewing/listening device 332 (e.g., an MP3 player, iPod™, Nook™, portable digital video player, cellular device, personal digital assistant, etc.). In yet another embodiment, the computer 302 may comprise a multi-touch device, mobile phone, gaming system, internet enabled television, television set top box, or other internet enabled device executing on various platforms and operating systems.

In one embodiment, the computer 302 operates by the general purpose processor 304A performing instructions defined by the computer program 310 under control of an operating system 308. The computer program 310 and/or the operating system 308 may be stored in the memory 306 and may interface with the user and/or other devices to accept input and commands and, based on such input and commands and the instructions defined by the computer program 310 and operating system 308, to provide output and results.

Output/results may be presented on the display 322 or provided to another device for presentation or further processing or action. In one embodiment, the display 322 comprises a liquid crystal display (LCD) having a plurality of separately addressable liquid crystals. Alternatively, the display 322 may comprise a light emitting diode (LED) display having clusters of red, green and blue diodes driven together to form full-color pixels. Each liquid crystal or pixel of the display 322 changes to an opaque or translucent state to form a part of the image on the display in response to the data or information generated by the processor 304 from the application of the instructions of the computer program 310 and/or operating system 308 to the input and commands. The image may be provided through a graphical user interface (GUI) module 318. Although the GUI module 318 is depicted as a separate module, the instructions performing the GUI functions can be resident or distributed in the operating system 308, the computer program 310, or implemented with special purpose memory and processors.

In one or more embodiments, the display 322 is integrated with/into the computer 302 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 302 according to the computer program 310 instructions may be implemented in a special purpose processor 304B. In this embodiment, the some or all of the computer program 310 instructions may be implemented via firmware instructions stored in a read only memory (ROM), a programmable read only memory (PROM) or flash memory within the special purpose processor 304B or in memory 306. The special purpose processor 304B may also be hardwired through circuit design to perform some or all of the operations to implement the present invention. Further, the special purpose processor 304B may be a hybrid processor, which includes dedicated circuitry for performing a subset of functions, and other circuits for performing more general functions such as responding to computer program 310 instructions. In one embodiment, the special purpose processor 304B is an application specific integrated circuit (ASIC).

The computer 302 may also implement a compiler 312 that allows an application or computer program 310 written in a programming language such as COBOL, Pascal, C++, FORTRAN, or other language to be translated into processor 304 readable code. Alternatively, the compiler 312 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 310 accesses and manipulates data accepted from I/O devices and stored in the memory 306 of the computer 302 using the relationships and logic that were generated using the compiler 312.

The computer 302 also optionally comprises an external communication device such as a modem, satellite link, Ethernet card, or other device for accepting input from, and providing output to, other computers 302.

In one embodiment, instructions implementing the operating system 308, the computer program 310, and the compiler 312 are tangibly embodied in a non-transient computer-readable medium, e.g., data storage device 320, which could include one or more fixed or removable data storage devices, such as a zip drive, floppy disc drive 324, hard drive, CD-ROM drive, tape drive, etc. Further, the operating system 308 and the computer program 310 are comprised of computer program 310 instructions which, when accessed, read and executed by the computer 302, cause the computer 302 to perform the steps necessary to implement and/or use the present invention or to load the program of instructions into a memory 306, thus creating a special purpose data structure causing the computer 302 to operate as a specially programmed computer executing the method steps described herein. Computer program 310 and/or operating instructions may also be tangibly embodied in memory 306 and/or data communications devices 330, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 302.

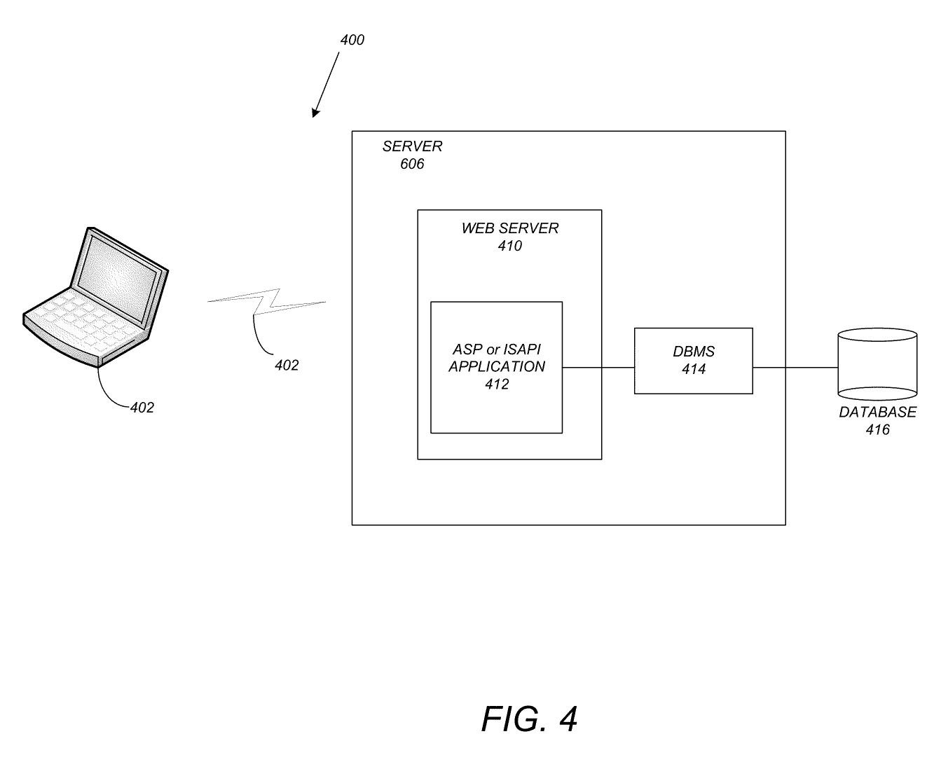

FIG. 4 schematically illustrates a typical distributed computer system 400 using a network 404 to connect client computers 302 to server computers 406. A typical combination of resources may include a network 404 comprising the Internet, LANs (local area networks), WANs (wide area networks), SNA (systems network architecture) networks, or the like, clients 202 that are personal computers or workstations (as set forth in FIG. 3), and servers 406 that are personal computers, workstations, minicomputers, or mainframes (as set forth in FIG. 3). However, it may be noted that different networks such as a cellular network (e.g., GSM [global system for mobile communications] or otherwise), a satellite based network, or any other type of network may be used to connect clients 302 and servers 406 in accordance with embodiments of the invention.

A network 404 such as the Internet connects clients 302 to server computers 406. Network 404 may utilize ethernet, coaxial cable, wireless communications, radio frequency (RF), etc. to connect and provide the communication between clients 302 and servers 406. Clients 302 may execute a client application or web browser and communicate with server computers 406 executing web servers 410. Such a web browser is typically a program such as MICROSOFT INTERNET EXPLORER™, MOZILLA FIREFOX™, OPERA™, APPLE SAFARI™, GOOGLE CHROMET™, etc. Further, the software executing on clients 302 may be downloaded from server computer 406 to client computers 302 and installed as a plug-in or ACTIVEX™ control of a web browser. Accordingly, clients 302 may utilize ACTIVEX™ components/component object model (COM) or distributed COM (DCOM) components to provide a user interface on a display of client 302. The web server 410 is typically a program such as MICROSOFT′S INTERNET INFORMATION SERVER®.

Web server 410 may host an Active Server Page (ASP) or Internet Server Application Programming Interface (ISAPI) application 412, which may be executing scripts. The scripts invoke objects that execute business logic (referred to as business objects). The business objects then manipulate data in database 416 through a database management system (DBMS) 414. Alternatively, database 416 may be part of, or connected directly to, client 302 instead of communicating/obtaining the information from database 416 across network 404. When a developer encapsulates the business functionality into objects, the system may be referred to as a component object model (COM) system. Accordingly, the scripts executing on web server 410 (and/or application 412) invoke COM objects that implement the business logic. Further, server 406 may utilize MICROSOFT′S™ Transaction Server (MTS) to access required data stored in database 416 via an interface such as ADO (Active Data Objects), OLE DB (Object Linking and Embedding DataBase), or ODBC (Open DataBase Connectivity).

Generally, these components 300-416 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 302 and 406 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 302 and 406.

### Software Embodiment Overview

Embodiments of the invention are implemented as a software application on a client 302 or server computer 406. Further, as described above, the client 302 or server computer 406 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems. Users may communicate and interact with the software application using a mobile device, client computer 302, portable device, etc.

As described above, client 302 or server computer 406 may integrate and provide the capabilities described above. In this regard, the platform and processing capabilities that provide the ability to recommend content may be performed by client 302, server 406, and/or a combination of client 302 and/or server 406.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for recommending content to a particular user comprising:
implementing, in a computer, a first content recommendation technique to generate a first content recommendation score relative to a particular piece of content and the particular user;
implementing a second content recommendation technique to generate a second content recommendation score relative to said particular piece of content and said particular user; and
reconciling said first and said second content recommendation scores to generate an overall content recommendation score for said particular piece of content and said particular user.

2. The computer-implemented method of claim 1, wherein the first content recommendation technique or second content recommendation technique is based on a characterization of particular piece of content.

3. The computer-implemented method of claim 1, wherein the first content recommendation technique or second content recommendation technique is based on tags assigned to the particular piece of content and the particular user.

4. The computer-implemented method of claim 1, wherein the first content recommendation technique or second content recommendation technique is based on a relationship score that is assigned between the particular piece of content and the particular user.

5. The computer-implemented method of claim 1, wherein the first content recommendation technique or second content recommendation technique is based on a frame score that is assigned to the particular piece of content or the particular user.

6. The computer-implemented method of claim 5, further comprising:
providing a pre-defined context of activities;
assigning point values to all activities that may occur within that pre-defined context;
tracking all activities for a single user or resource within said pre-defined context over a period of time;
determining a score value for each activity for said single user or resource within said pre-defined context over a period of time;
calculating a raw score for said single user or resource according to the total of all said determined score values; and
normalizing that raw score value against scores of a population of other users or resources within said pre-determined context to provide a comparative scoring for users or resources within said pre-defined context.

7. The computer-implemented method of claim 1, wherein said first content recommendation score is weighted relative to said second content recommendation score during reconciliation of said first and second content recommendation scores.

8. A system for recommending content to a particular user comprising:
a computer having a processor and memory;
a first content recommendation technique, executed by the processor, wherein the first content recommendation technique generates a first content recommendation score relative to a particular piece of content and the particular user;
a second content recommendation technique, executed by the processor, wherein the second content recommendation technique generates a second content recommendation score relative to said particular piece of content and said particular user; and
a reconciliation process, executed by the processor, wherein the reconciliation process reconciles said first and said second content recommendation scores to generate an overall content recommendation score for said particular piece of content and said particular user.

9. The system of claim 8, wherein the first content recommendation technique or second content recommendation technique is based on a characterization of particular piece of content.

10. The system of claim 8, wherein the first content recommendation technique or second content recommendation technique is based on tags assigned to the particular piece of content and the particular user.

11. The system of claim 8, wherein the first content recommendation technique or second content recommendation technique is based on a relationship score that is assigned between the particular piece of content and the particular user.

12. The system of claim 8, wherein the first content recommendation technique or second content recommendation technique is based on a frame score that is assigned to the particular piece of content or the particular user.

13. The system of claim 12, wherein the first content recommendation technique is configured to:
provide a pre-defined context of activities;
assign point values to all activities that may occur within that pre-defined context;
track all activities for a single user or resource within said pre-defined context over a period of time;
determine a score value for each activity for said single user or resource within said pre-defined context over a period of time;
calculate a raw score for said single user or resource according to the total of all said determined score values; and
normalize that raw score value against scores of a population of other users or resources within said pre-determined context to provide a comparative scoring for users or resources within said pre-defined context.

14. The system of claim 8, wherein said first content recommendation score is weighted relative to said second content recommendation score during reconciliation of said first and second content recommendation scores.
